(19) United States
(12) Patent Application Publication
(10) Pub. No.: US 2018/0144645 A1
(43) Pub. Date: May 24, 2018

(54) SYSTEM AND METHOD FOR DETECTING HUMANS BY AN UNMANNED AUTONOMOUS VEHICLE

(71) Applicant: Wal-Mart Stores, Inc., Bentonville, AR (US)

(72) Inventors: Timothy M. Fenton, Bentonville, AR (US); Donald R. High, Noel, MO (US); Nicholas Ray Antel, Springdale, AR (US)

(21) Appl. No.: 15/815,936

(22) Filed: Nov. 17, 2017

Related U.S. Application Data
(60) Provisional application No. 62/424,657, filed on Nov. 21, 2016.

(51) Int. Cl. G08G 5/00; H04B 7/185; B64C 39/02; G05D 1/00

(52) U.S. Cl. CPC G08G 5/0069; H04B 7/18506; B64C 2201/146; G05D 1/0055; B64C 2201/128; B64C 39/024

(57) ABSTRACT

An unmanned vehicle is configured to deliver packages or other payloads includes a first sensor, a second sensor, a third sensor, and a control circuit. The first sensor is configured to sense infrared energy, and the second sensor is configured to sense visible light viewable by a human observer. The third sensor is configured to sense radio frequency (RF) energy from a mobile wireless device. The control circuit is coupled to the first sensor, the second sensor, and the third sensor, and is configured to determine the presence of a human associated with the mobile wireless device using the sensed infrared energy, the sensed visible light, and the sensed RF energy.

### CROSS-REFERENCE TO RELATED APPLICATION

This application claims the benefit of the following U.S. Provisional Application No. 62/424,657 filed Nov. 21, 2016, which is incorporated herein by reference in its entirety.

### TECHNICAL FIELD

This invention relates generally to unmanned vehicles such as aerial drones, and more particularly, to approaches for detecting humans by unmanned vehicles.

### BACKGROUND

When an aerial drone flies in an environment where people are likely to be present, the drone must avoid these people to avoid injury to the people, and possible damage to the drones. Drones sometimes deploy technology that senses people and objects, and helps the drone avoid the people and objects as the drone moves within a given environment.

Various types of collision avoidance technology for drones has been developed. Some of these approaches rely upon using cameras to obtain images of the environment of the drone, and then determining whether humans are present in these images. Unfortunately, the quality of these images is often not good, and this can lead to either false identifications of humans (when humans are, in fact, not present in the image), or completely missing the detection of humans (when the humans are actually present in the image).

The above-mentioned problems have led to some user dissatisfaction with these approaches.

### BRIEF DESCRIPTION OF THE DRAWINGS

Disclosed herein are embodiments of systems, apparatuses and methods pertaining to determining the presence of a human by an unmanned vehicle. This description includes drawings, wherein:

FIG. 1 is a block diagram of a system that determines the presence of a human by an unmanned vehicle in accordance with some embodiments;

FIG. 2 is a block diagram of an unmanned vehicle that determines the presence of a human in accordance with some embodiments;

FIG. 3 is a flowchart of an approach that determines the presence of a human in accordance with some embodiments;

FIG. 4 is a flowchart of an approach showing details of correlating a fused image with radio frequency (RF) data in accordance with some embodiments;

FIG. 5 is one example of a fused image including both visible and infrared data in accordance with some embodiments;

FIG. 6 are graphs of RF data used to determine the presence of a human in accordance with some embodiments;

FIG. 7 is a block diagram of an apparatus that determines the presence of a human in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for determining the presence of a human and/or any other living being such as animals by an unmanned autonomous vehicle (such as an aerial drone). These approaches are reliable and allow the accurate identification of a human within the operating environment of an unmanned vehicle.

In aspects, three types of data are analyzed together to determine the presence of a human. Infrared and visible light data is fused together into a fused composite pseudo-IR image, which the drone may search for objects that look approximately like people (via computer vision algorithms well-known in the art) and that have the temperature properties expected of people (e.g., exposed skin typically being in the 80-90 degree F. range).

A scan is also made for radio frequency (RF) energy emitted by wireless devices likely to be carried by a human. For example, the RF energy may be sensed by a small software defined radio (SDR) capable of fast scanning RF bands, which will have uplink energy from a cellphone on them. The RF regions of interest may include cellular bands (e.g., across the various 2G, 3G, 4G bands, Bluetooth, and Wi-Fi bands). Other examples are possible. Since uplink energy from cellular devices is weak and hard to detect unless the sensor is close (e.g., hundreds of meters or less distance to the person) to the wireless device, any discovery of uplink energy by the unmanned vehicle may (with some signal processing to determine a line of bearing from the drone to the cellular phone) be correlated and fused with the fused composite pseudo-IR image to determine the presence of a human and thus avoid the human.

In other aspects, the unmanned vehicle is equipped with the capability to use RSSI and/or multilateration based technology to determine the position of the unmanned vehicle. These approaches may receive Wi-Fi signals broadcast in, for example, residential and commercial buildings. The unmanned vehicle may use the received signal strength of a wireless device to determine the distance to that device and to stay a safe distance from human associated with that device.

In some embodiments, an unmanned vehicle (e.g., an aerial drone or ground vehicle) delivers packages or other payloads includes a first sensor, a second sensor, a third sensor, and a control circuit. The first sensor is configured to sense infrared energy, and the second sensor is configured to sense visible light viewable by a human observer. The third sensor is configured to sense RF energy from a mobile wireless device. The control circuit is coupled to the first sensor, the second sensor, and the third sensor, and is configured to determine the presence of a human associated with the mobile wireless device using the sensed infrared energy, the sensed visible light, and the sensed RF energy.

In aspects, the control circuit is configured to produce a composite image by fusing together the sensed infrared energy and the sensed visible light energy. The control circuit is further configured to analyze the composite image for the presence of a human form, and analyze the sensed RF energy for the presence of uplink energy produced by the mobile wireless device. The control circuit may be further configured to correlate the uplink energy with the human form to determine the presence of the human associated with the mobile wireless device carried by the human form.

In some examples, the control circuit is configured to determine a line of bearing to the mobile wireless device. In other examples, the control circuit determines a distance to the wireless device.

In examples, the composite image presents temperature properties that are associated with humans and a visible image showing the same field of view as the infrared image. Selected portions of the infrared image and/or the visible image may be used to that the composite image does not become unreadable.

In other examples, the control circuit is configured to create electronic control signals that are effective to maneuver the unmanned vehicle so as to avoid a collision with the human. In other aspects, the control circuit forms electronic control signals that are effective to control the operation of the unmanned vehicle so as to maintain a predetermined distance between the human and the unmanned vehicle. In one example, the control circuit determines the received signal strengths of RF signals received from the mobile wireless device and the received signal strengths are used to form the electronic control signals.

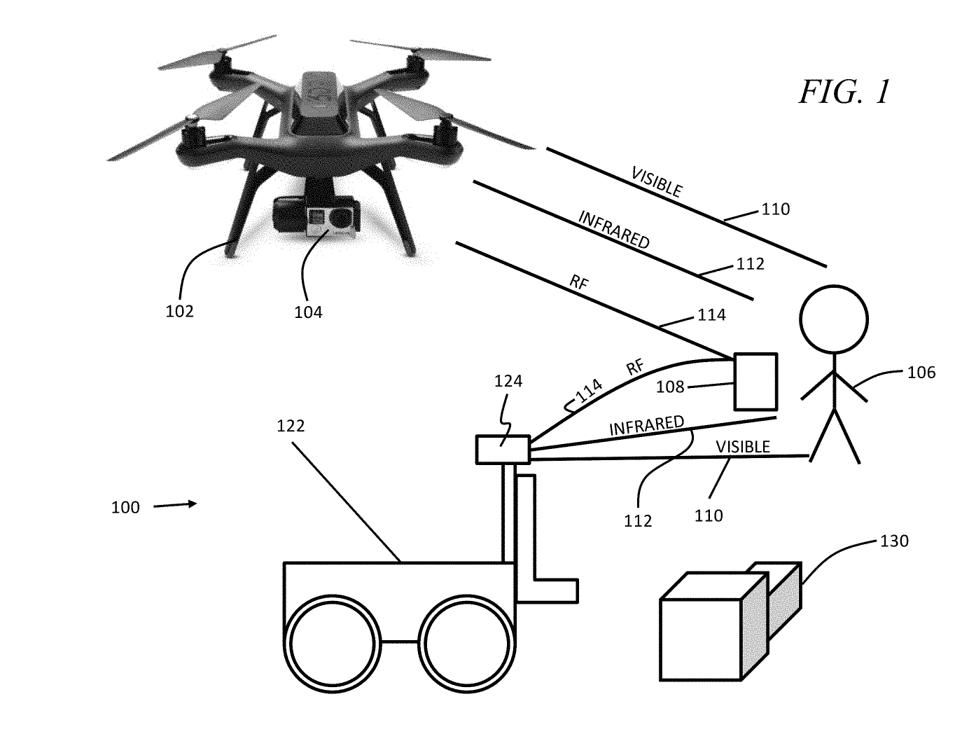

Referring now to FIG. 1, one example of a system 100 that determines the presence of a human by one or more unmanned vehicles is described. The system 100 includes a drone 102 (including sensors 104), a person 106 (with a wireless device 108), an unmanned vehicle 122 (with sensors 124), and products 130. In one example, the system of FIG. 1 is deployed in a warehouse or store. However, it will be appreciated that these elements may be deployed in any interior or exterior setting.

The drone 102 is an unmanned autonomous vehicle that is configured to navigate by itself without any centralized control. The drone 102 may include any type of propulsion system (such as engine and propellers), and can fly in both interior and exterior spaces.

The unmanned vehicle 122 is an unmanned autonomous vehicle that is configured to navigate by itself without any centralized control. The drone unmanned vehicle 122 may include any type of propulsion system so that it can move on the ground in any exterior or interior space. The products 130 may be any type of consumer product that is situated in a warehouse or store.

The sensors 104 and 124 include sensors to sense visible light 110, infrared energy 112, and RF energy 114 (from the wireless device 108 and possibly other sources).

The wireless device 108 is any type of mobile wireless service such as a cellular phone, tablet, personal digital assistant, or personal computer. Other examples are possible.

In operation, the sensors 104 and 124 sense visible light 110, infrared energy 112, and RF energy (from the wireless device 108 and possibly from other sources). A composite image is produced at the drone 102 or the unmanned vehicle 122. The composite image is produced by fusing together the sensed infrared energy and the sensed visible light energy. The composite image is analyzed for the presence of a human form. The sensed RF energy 114 is analyzed for the presence of uplink energy produced by the mobile wireless device 108. The uplink energy is correlated with the human form to determine the presence of the human 106 associated with the mobile wireless device 108 carried by the human 106.

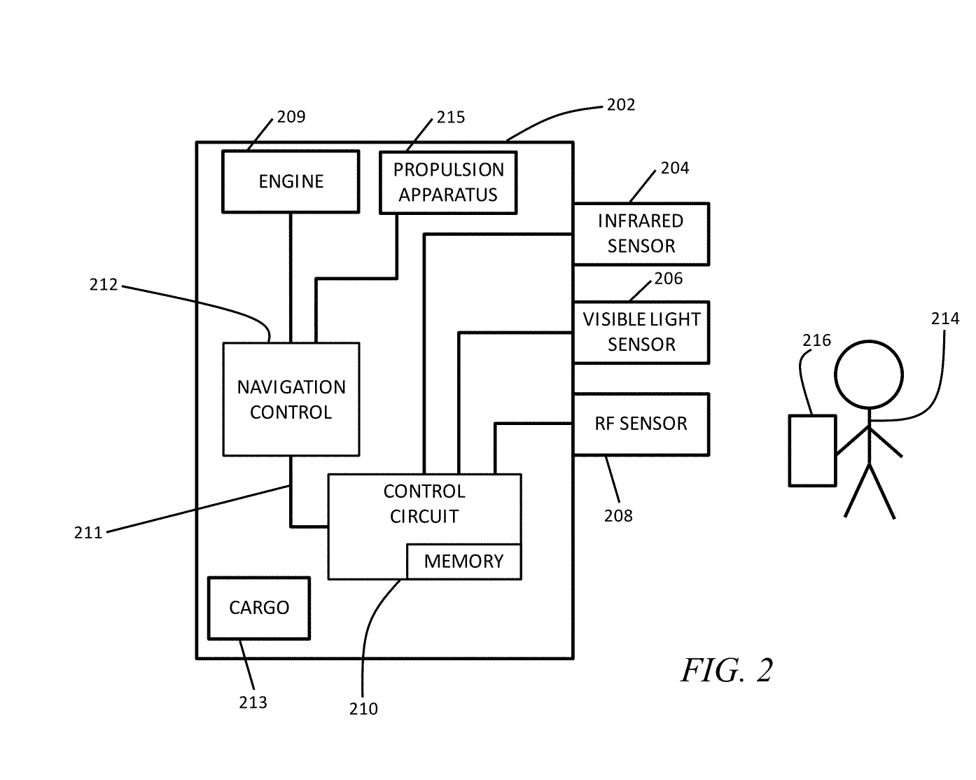

Referring now to FIG. 2, an unmanned vehicle 202 that determines the presence of a human 214 is described. The unmanned vehicle 202 includes an infrared sensor 204, a visible light sensor 206, an RF energy sensor 208, a control circuit 210, and a navigation control circuit 212.

The unmanned vehicle 202 may be an aerial drone or a ground vehicle. In either case, the unmanned vehicle 202 is configured to navigate by itself without any centralized control.

The infrared sensor 204 is configured to detect energy in the infrared frequency range. The visible light sensor 206 is configured to sense light and images in the frequency range that is visible by humans. The RF energy sensor 208 is configured to sense uplink energy in frequency bands utilized by wireless devices (e.g., cellular frequency bands).

The navigation control circuit 212 may be implemented as any combination of hardware or software elements. In one example, the navigational control circuit 212 includes a microprocessor that executes computer instructions stored in a memory. The navigation control circuit 212 may receive instructions or signals from the control circuit 210 as to where to navigate the vehicle 202. Responsively, the navigation control circuit 212 may adjust propulsion elements of the vehicle 202 to follow these instructions. For example, the navigation control circuit 212 may receive instructions from the control circuit 210 to turn the vehicle 45 degrees, and adjust the height of the vehicle to 20 feet (assuming the vehicle is a drone). The navigation control circuit 212 causes the vehicle 202 to turn 45 degrees and activates an engine 209 and a propulsion apparatus 215 (e.g., the propellers) to adjust the height to 20 feet. The engine 209 may be any type of engine using any type of fuel or energy to operate. The propulsion element 215 may be any device or structure that is used to propel, direct, and/or guide the vehicle 202. The vehicle 202 includes a cargo 213, which may be, for example, a package.

The term control circuit refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 210 may be configured (for example, by using corresponding programming stored in a memory as will be well understood by those skilled in the art) to carry out one or more of the steps, actions, and/or functions described herein.

The control circuit 210 is configured to receive sensed information from the infrared sensor 204, visible light sensor 206, and RF energy sensor 208 and, if required provide any conversion functions (e.g., convert any analog sensed data into digital data that can be utilized and processed by the control circuit 210).

The control circuit 210 is configured to determine the presence of the human 214 associated with a mobile wireless device 216 (e.g., a cellular phone, tablet, personal digital assistant, or personal computer to mention a few examples) using the sensed infrared energy, the sensed visible light, and the sensed RF energy.

In aspects, the control circuit 210 is configured to produce a composite image by fusing together the sensed infrared energy and the sensed visible light energy. The creation of composite images (e.g., laying one image over another image) is well known to those skilled in the art. The control circuit 210 is further configured to analyze the composite image for the presence of a human form and analyze the sensed RF energy for the presence of uplink energy produced by the mobile wireless device 216. The control circuit 210 may be further configured to correlate the uplink energy with the human form to determine the presence of the human 214 associated with the mobile wireless device 216 carried by the human 214.

In some examples, the control circuit 210 is configured to determine a line of bearing to the mobile wireless device 216. In other examples, the control circuit 210 determines a distance to the wireless device 216.

In examples, the composite image presents temperature properties that are associated with the human 214 and a visible image of the same field of view as the infrared image. Selected portions of the infrared image and/or the visible image (rather than the entirety of either image may be used so that the composite image does not become unreadable by attempting to present too much information. For example, irrelevant information (e.g., details from inanimate objects, or reflections) from the visible image may be ignored and not used in the composite image.

In other examples, the control circuit 210 is configured to create electronic control signals (sent to navigation control circuit 212 via connection 211) that are effective to maneuver the unmanned vehicle so as to avoid a collision with the human. In other aspects, the control circuit 210 forms electronic control signals (sent to navigation control circuit 212 via connection 211) that are effective to control the operation of the unmanned vehicle 202 so as to maintain a predetermined distance between the human 214 and the unmanned vehicle 202. In one example, the control circuit 210 determines the received signal strengths of RF signals received from the mobile wireless device 216 and the received signal strengths are used to form the electronic control signals.

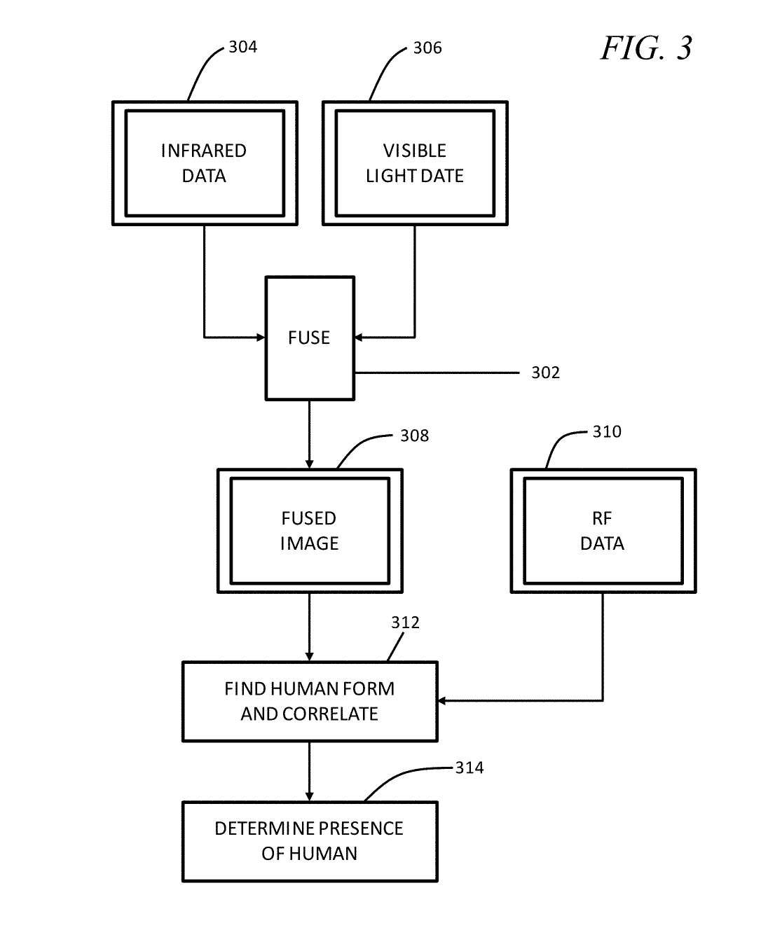

Referring now to FIG. 3, one example of an approach that determines the presence of a human is described. Infrared data 304 and visible light data 306 are fused together at step 302. The result of this step is the creation of a fused image 308. The fused image includes both infrared data and visible light data.

At step 312, the fused image 308 is searched for a human form. This can be accomplished, for example, by using image analysis software that is well known to those skilled in the art. Once the human form is found in the fused image, the form is correlated with RF data 310.

At step 314, the presence of a human is determined. For example, when a certain detected RF energy amount exceeds a threshold and matches a position of the human form, a determination may be made that a human is present.

At step 316, the unmanned vehicle is navigated to avoid the human. For example, the propulsion system in the vehicle may be controlled and directed to cause the vehicle to take a route that avoids contact with the human.

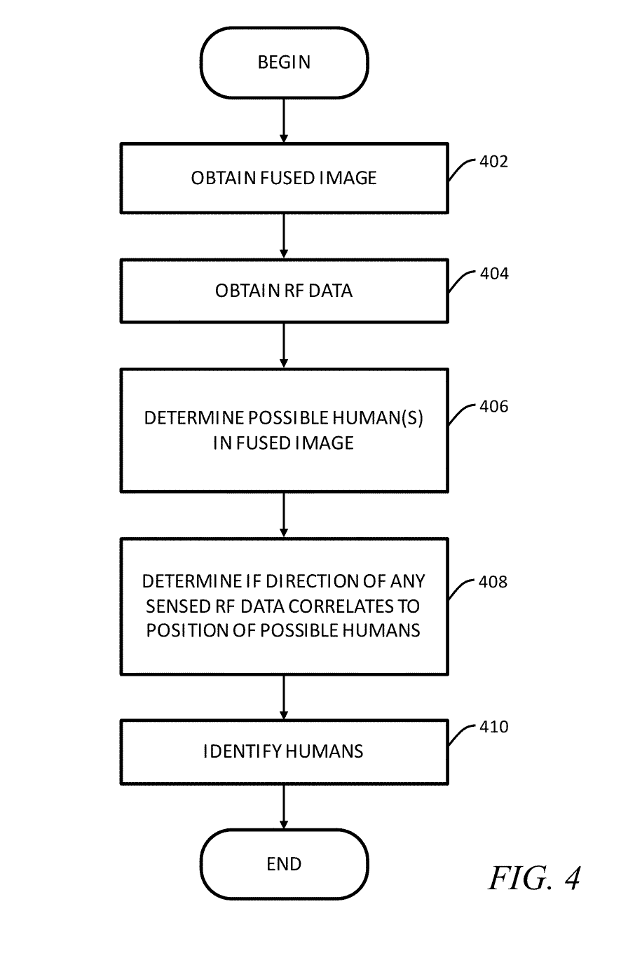

Referring now to FIG. 4, one example of an approach showing details of correlating a fused image with RF data is described.

At step 402, fused data is obtained. The fused data is a composite image formed from sensed infrared data and sensed visible light data.

At step 404, RF data is obtained. The RF data includes uplink data that may be from a wireless device operated by a human.

At step 406, a determination is made as to the existence of a human form in the fused data. Well-known image analysis software may be used to analyze the composite image. For example, a search may be made for an area in the image having certain thermal properties (e.g., the temperature for humans), and for imagery that matches human physical elements (e.g., heads, bodies, arms, legs, and so forth). If the analysis determines that the human physical elements exist at a human temperature range, it may be determined that a human form exists in the composite image.

At step 408, the RF data is examined to determine whether the energy is from a wireless device (e.g., it is not background noise). The directionality of uplink energy from the sensor is also made using known techniques. A determination may then be made as to whether the human form detected at step 406 correlates with the direction of the energy.

At step 412, a determination is made so as to determine whether the human is present. In these regards, there may be a set of conditions that (once met) signify the presence of a human. For example, when the direction of detected RF energy matches (correlates) with the location of a human form in the composite image, then a determination may automatically be made that a human is present. In other examples, other conditions may be examined (e.g., whether the RF energy is above a threshold value) before an affirmative determination of human presence can be made. It will be appreciated that various combinations of conditions and different thresholds can be used to determine whether a human is present.

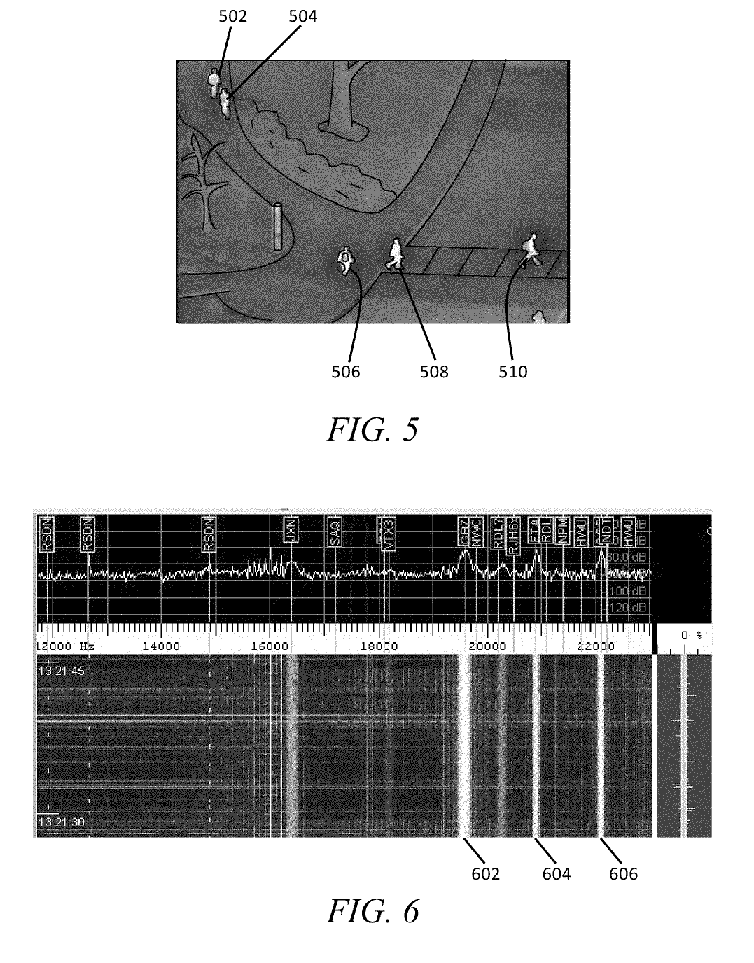

Referring now to FIG. 5, one example of a fused or composite image (with both visible and infrared data) is described. The fused image shown in FIG. 5 includes both visible light imagery and infrared light imagery, and is of an outdoor scene. The infrared light imagery is represented over a spectrum of shadings (or colors) with the darkest shade (or color) representing the coldest temperature and the brightest or lightest shade (or color) representing the warmest temperature for objects. In other words, different shades (or colors) represent different temperatures. Both the visible light image and the infrared image have the same field of view.

For example, one particular shading (or similar shadings) may correspond the temperatures of the human body. A visible light image is overlaid onto the infrared image. It will be realized that varying amounts of data from the visible light image may be overlaid onto the infrared image. For example, if too much visible light data is included the fused image, then the fused image may become unreadable or unusable. As a result, selective portions of each of the visible light image and infrared image may be used to form the fused image.

As shown in FIG. 5, the fused image includes human FIGS. 502, 504, 506, 508, and 510. It can be seen that these FIGS. 502, 504, 506, 508, and 510 are of a lighter color (indicating a greater temperature than the background environment). It will also be appreciated that discernable human features (e.g., arms, legs, and heads, to mention a few examples) are discernable because a visible light image is part of the fused image. The visible light image also helps in discerning paths, sidewalks, trees, and bushes in the example image of FIG. 5.

Since both visible light and infrared images are used, it will be understood that there is a greater likelihood that humans can be detected, while false detections of humans will be avoided. It will also be understood that the example of FIG. 5 shows a view outdoors, but that these approaches are applicable to indoor locations (e.g., the interior of warehouse or stores). Additionally, the image of FIG. 5 shows a fused image at a somewhat long distance. It will be appreciated that the approaches are applicable at much shorter distances (where these approaches may not only determine the presence of a human, but other information about the human such as their height, weight, or identity).

Referring now to FIG. 6, graphs of RF data used to determine the presence of a human are described. The top graph shows a plot of frequency versus response while the bottom graph shows a histogram of frequencies. RF energy spikes at frequencies 602, 604, and 606 indicating one or more possible wireless devices. The direction of this energy from the unmanned device may be determined as can be the distance to the wireless device (e.g., using RSSI approaches that are well known in the art). All of this information can be correlated with a fused image to determine the presence of one or more humans.

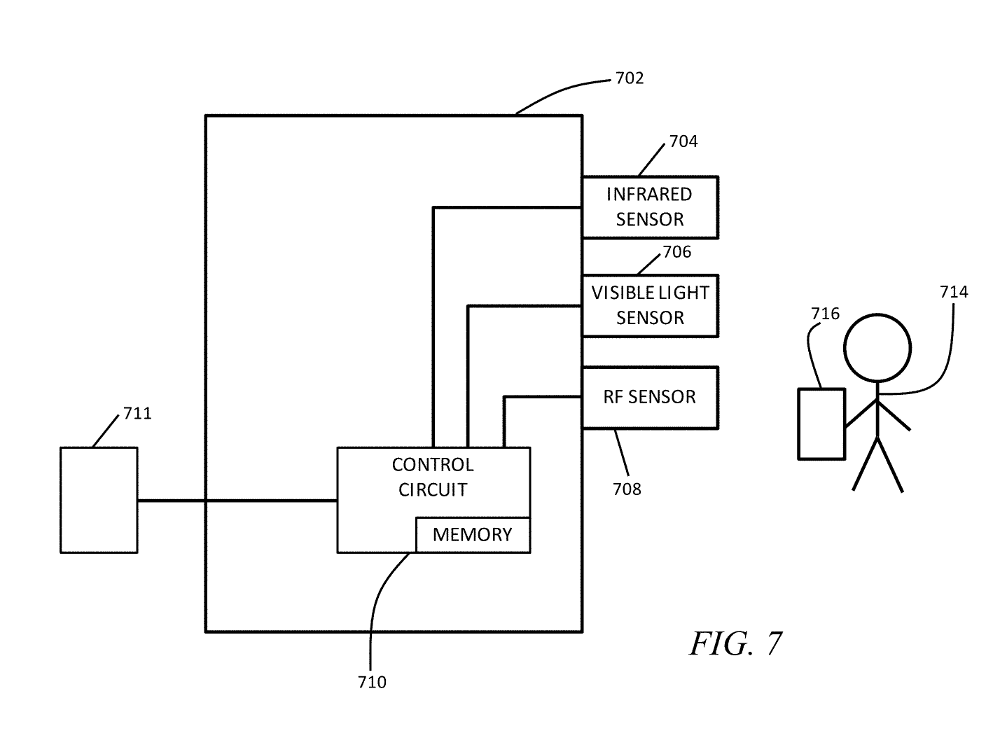

Referring now to FIG. 7, an apparatus 702 that determines the presence of a human 714 is described. The apparatus 702 includes an infrared sensor 704, a visible light sensor 706, an RF energy sensor 708, and a control circuit 710. The control circuit 710 may be coupled to another device 711 (e.g., a display device or a recording device to mention two examples). In aspects, the apparatus 702 includes a housing that encloses (or has attached to it) some or all of these elements.

The apparatus 702 may be stationary. For example, the apparatus 702 may be permanently or semi-permanently attached to a wall or ceiling. In other examples, the apparatus 702 may be movable. For example, the apparatus, may be attached to a vehicle, person, or some other entity that moves.

The infrared sensor 704 is configured to detect energy in the infrared frequency range. The visible light sensor 706 is configured to sense light and images in the frequency range that is visible by humans. The RF energy sensor 708 is configured to sense uplink energy in frequency bands utilized by wireless devices (e.g., cellular frequency bands).

As mentioned, the term control circuit refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 710 may be configured (for example, by using corresponding programming stored in a memory as will be well understood by those skilled in the art) to carry out one or more of the steps, actions, and/or functions described herein.

The control circuit 710 is configured to received sensed information from the infrared sensor 704, visible light sensor 706, and RF energy sensor 708 and, if required provide any conversion functions (e.g., convert any analog sensed data into digital data that can be utilized and processed by the control circuit 710).

The control circuit 710 is configured to determine the presence of the human 714 associated with a mobile wireless device 716 (e.g., a cellular phone, tablet, personal digital assistant, or personal computer to mention a few examples) using the sensed infrared energy, the sensed visible light, and the sensed RF energy.

In aspects, the control circuit 710 is configured to produce a composite image by fusing together the sensed infrared energy and the sensed visible light energy. The creation of composite images (e.g., laying one image over another image) is well known to those skilled in the art. The control circuit 710 is further configured to analyze the composite image for the presence of a human form and analyze the sensed RF energy for the presence of uplink energy produced by the mobile wireless device 716. The control circuit 710 may be further configured to correlate the uplink energy with the human form to determine the presence of the human 714 associated with the mobile wireless device 716 carried by the human 714.

In some examples, the control circuit 710 is configured to determine a line of bearing to the mobile wireless device 716. In other examples, the control circuit 710 determines a distance to the wireless device 716.

In examples, the composite image presents temperature properties that are associated with the human 714 and a visible image of the same field of view as the infrared image. Selected portions of the infrared image and/or the visible image (rather than the entirety of either image) may be used to that the composite image does not become unreadable by attempting to present too much information. For example, irrelevant information (e.g., details from inanimate objects, or reflections) from the visible image may be ignored and not used in the composite image.

The composite image and information concerning the location of the human 714 can be used in a variety of different ways. In aspects, this information may be displayed at the device 711 for various purposes. For example, the composite image and bearing information can be displayed at the device 711. This allows a person at the device 711 to avoid a collision with the human 714. The device 711 may be a smartphone and the person with the device 711 may be travelling in a vehicle, in one example.

In other aspects, the composite image and information can be sent to other processing elements or devices, or used to control the operation of these devices. For instance, the information can be used to steer or otherwise direct a vehicle to avoid the human 714. In still other examples, the information can be reported (e.g., broadcast) to other humans or vehicles so that they can avoid the human 714.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. An unmanned vehicle that is configured to deliver packages along a package delivery route to customers, comprising:
a package that is to be delivered along a package delivery route;
an engine and a propulsion apparatus that are configured to move and direct the unmanned vehicle along the delivery route;
a first sensor, the first sensor configured to sense infrared energy;
a second sensor, the second sensor being configured to sense visible light viewable by a human observer;
a third sensor, the third sensor configured to sense radio frequency (RF) energy from a mobile wireless device;
a control circuit coupled to the propulsion apparatus, the first sensor, the second sensor, and the third sensor, the control circuit being configured to determine the presence and location of a human associated with the mobile wireless device using the sensed infrared energy, the sensed visible light, and the sensed RF energy, and the control circuit being configured to control and direct the propulsion apparatus to navigate the unmanned vehicle so as to avoid colliding with the detected human.

2. The unmanned vehicle of claim 1, wherein the control circuit is configured to produce a composite image by fusing together the sensed infrared energy and the sensed visible light energy, and analyze the composite image for the presence of a human form and analyze the sensed RF energy for the presence of uplink energy produced by the mobile wireless device,

3. The unmanned vehicle of claim 2, wherein the control circuit is configured to correlate the uplink energy with the human form to determine the presence of the human associated with the mobile wireless device carried by the human form.

4. The unmanned vehicle of claim 2, wherein the control circuit is configured to determine a line of bearing to the mobile wireless device.

5. The unmanned vehicle of claim 2, wherein the composite image presents temperature properties that are associated with humans.

6. The unmanned vehicle of claim 1, wherein the control circuit is configured to create electronic control signals that are effective to maneuver the unmanned vehicle so as to avoid a collision with the human.

7. The unmanned vehicle of claim 1, wherein the unmanned vehicle is an unmanned aerial drone.

8. The unmanned vehicle of claim 1, wherein the control circuit is configured to determine a distance to the human.

9. The unmanned vehicle of claim 1, wherein the control circuit forms electronic control signals that are effective to control the operation of the unmanned vehicle so as to maintain a predetermined distance between the human and the unmanned vehicle.

10. The unmanned vehicle of claim 9, wherein the control circuit determines the received signal strengths of RF signals received from the mobile wireless device and the received signal strengths are used to form the electronic control signals.

11. An apparatus that is configured to determine the presence of a human, the apparatus comprising:
a first sensor, the first sensor configured to sense infrared energy;
a second sensor, the second sensor being configured to sense visible light viewable by a human observer;
a third sensor, the third sensor configured to sense radio frequency (RF) energy from a mobile wireless device;
a control circuit coupled to the first sensor, the second sensor, and the third sensor, the control circuit configured to determine the presence and position of a human associated with the mobile wireless device using the sensed infrared energy, the sensed visible light, and the sensed RF energy.

12. The apparatus of claim 11, wherein the apparatus is disposed at a stationary location.

13. The apparatus of claim 11, wherein the apparatus is disposed at a moving device.

14. The apparatus of claim 11, wherein the control circuit is configured to produce a composite image by fusing together the sensed infrared energy and the sensed visible light energy, and analyze the composite image for the presence of a human form and analyze the sensed RF energy for the presence of uplink energy produced by the mobile wireless device.

15. The apparatus of claim 14, wherein the control circuit is configured to correlate the uplink energy with the human form to determine the presence of the human associated with the mobile wireless device carried by the human form.

16. The apparatus of claim 14, wherein the control circuit is configured to determine a line of bearing to the mobile wireless device.

17. A method of using an unmanned vehicle to deliver packages in a package delivery route and avoid collisions with humans while proceeding along the route, comprising:
sensing infrared energy at a first sensor deployed at the unmanned vehicle;
sensing visible light at a second sensor deployed at the unmanned vehicle;
sensing radio frequency (RF) energy at a third sensor deployed at the unmanned vehicle, the sensed RF energy originating from a mobile wireless device;
determining the presence of a human associated with the mobile wireless device using the sensed infrared energy, the sensed visible light, and the sensed RF energy.

18. The method of claim 17, wherein determining the presence of a human comprises producing a composite image by fusing the sensed infrared energy and the sensed visible light energy, analyzing the composite image for the presence of a human form, and analyzing the sensed RF energy for the presence of uplink energy produced by a mobile wireless device.

19. The method of claim 18, further comprising correlating the uplink energy with the human form to determine the presence of a human associated with the mobile wireless device.

20. The method of claim 18, where the correlating comprises determining a line of bearing to the mobile wireless device.
